(19) United States
(12) Patent Application Publication
(10) Pub. No.: US 2007/0116883 A1
(43) Pub. Date: May 24, 2007

(54) PROCESS FOR FORMING THERMAL BARRIER COATING RESISTANT TO INFILTRATION

(75) Inventors: Mark Daniel Gorman, West Chester, OH (US); Brian Thomas Hazel, Cincinnati, OH (US); John Frederick Ackerman, Laramie, WY (US); David Forrest Dye, Cincinnati, OH (US)

Correspondence Address: HARTMAN AND HARTMAN, P.C., 552 EAST 700 NORTH, VAIPARAISO, IN, 46383, US

(73) Assignee: GENERAL ELECTRIC COMPANY, Schenectady, NY (US)

(21) Appl. No.: 11/164,418

(22) Filed: Nov. 22, 2005

(51) Int. Cl. C23C 4/00; B05D 1/08

(52) U.S. Cl. 427/446

(57) ABSTRACT

A process for protecting a thermal barrier coating. The process entails applying to a surface of the coating a liquid containing one or more of aluminum alkoxides, aluminum beta-diketonates, aluminum carboxylates, and aluminum alkyls. The liquid is applied so as to form a liquid film on the surface, and has viscosity and wetting properties that cause the liquid to infiltrate porosity within the coating beneath its surface. The coating is then heated to convert the alumina precursor to alumina. A first portion of the alumina forms a surface deposit on the coating surface, while a second portion of the alumina forms an internal deposit within the porosity of the coating. The surface deposit overlying the coating is available for sacrificial reaction with CMAS, and the internal deposit maintains a level of CMAS protection in the event the surface deposit is breached or lost through spallation, erosion, and/or consumption.

### BACKGROUND OF THE INVENTION

This invention generally relates to coatings for components exposed to high temperatures, such as the hostile thermal environment of a gas turbine engine. More particularly, this invention is directed to a protective coating for a thermal barrier coating on a gas turbine engine component, in which the protective coating is resistant to infiltration by contaminants present in the operating environment of a gas turbine engine.

Hot section components of gas turbine engines are often protected by a thermal barrier coating (TBC), which reduces the temperature of the underlying component substrate and thereby prolongs the service life of the component. Ceramic materials and particularly yttria-stabilized zirconia (YSZ) are widely used as TBC materials because of their high temperature capability, low thermal conductivity, and relative ease of deposition by plasma spraying, flame spraying and physical vapor deposition (PVD) techniques. Plasma spraying processes such as air plasma spraying (APS) yield noncolumnar coatings characterized by a degree of inhomogeneity and porosity, and have the advantages of relatively low equipment costs and ease of application. TBC's employed in the highest temperature regions of gas turbine engines are often deposited by PVD, particularly electron-beam PVD (EBPVD), which yields a strain-tolerant columnar grain structure. Similar columnar microstructures with a degree of porosity can be produced using other atomic and molecular vapor processes.

To be effective, a TBC must strongly adhere to the component and remain adherent throughout many heating and cooling cycles. The latter requirement is particularly demanding due to the different coefficients of thermal expansion (CTE) between ceramic materials and the substrates they protect, which are typically superalloys, though ceramic matrix composite (CMC) materials are also used. An oxidation-resistant bond coat is often employed to promote adhesion and extend the service life of a TBC, as well as protect the underlying substrate from damage by oxidation and hot corrosion attack. Bond coats used on superalloy substrates are typically in the form of an overlay coating such as MCrAlX (where M is iron, cobalt and/or nickel, and X is yttrium or another rare earth element), or a diffusion aluminide coating. During the deposition of the ceramic TBC and subsequent exposures to high temperatures, such as during engine operation, these bond coats form a tightly adherent alumina (Al₂O₃) layer or scale that adheres the TBC to the bond coat.

The service life of a TBC system is typically limited by a spallation event driven by bond coat oxidation, increased interfacial stresses, and the resulting thermal fatigue. In addition to the CTE mismatch between a ceramic TBC and a metallic substrate, spallation can be promoted as a result of the TBC being contaminated with compounds found within a gas turbine engine during its operation. Notable contaminants include such oxides as calcia, magnesia, alumina and silica, which when present together at elevated temperatures form a compound referred to herein as CMAS. CMAS has a relatively low melting temperature of about 1225° C. (and possibly lower, depending on its exact composition), such that during engine operation the CMAS melts and infiltrates the porosity within the cooler subsurface regions of the TBC, where it resolidifies. As a result, during thermal cycling TBC spallation is likely to occur from the infiltrated solid CMAS interfering with the strain-tolerant nature of columnar TBC and the CTE mismatch between CMAS and the TBC material, particularly TBC deposited by PVD and APS due to the ability of the molten CMAS to penetrate their columnar and porous grain structures, respectively. Another detriment of CMAS is that the bond coat and substrate underlying the TBC are susceptible to corrosion attack by alkali deposits associated with the infiltration of CMAS.

Various studies have been performed to find coating materials that are resistant to infiltration by CMAS. Notable examples are commonly-assigned U.S. Pat. Nos. 5,660,885, 5,773,141, 5,871,820 and 5,914,189 to Hasz et al., which disclose three types of coatings to protect a TBC from CMAS-related damage. These protective coatings are generally described as being impermeable, sacrificial, or non-wetting to CMAS. Impermeable coatings are defined as inhibiting infiltration of molten CMAS, and include silica, tantala, scandia, alumina, hafnia, zirconia, calcium zirconate, spinels, carbides, nitrides, silicides, and noble metals such as platinum. Sacrificial coatings are said to react with CMAS to increase the melting temperature or the viscosity of CMAS, thereby inhibiting infiltration. Suitable sacrificial coating materials include silica, scandia, alumina, calcium zirconate, spinels, magnesia, calcia, and chromia. As its name implies, a non-wetting coating reduces the attraction between the solid TBC and the liquid (e.g., molten CMAS) in contact with it. Suitable non-wetting materials include silica, hafnia, zirconia, beryllium oxide, lanthana, carbides, nitrides, silicides, and noble metals such as platinum. According to the Hasz et al. patents, an impermeable coating or a sacrificial coating can be deposited directly on the TBC, and may be followed by a layer of an impermeable coating (if a sacrificial coating was deposited first), a sacrificial coating (if the impermeable coating was deposited first), or a non-wetting coating. If used, the non-wetting coating is the outermost coating of the protective coating system.

Other coating systems resistant to CMAS have been proposed, including those disclosed in commonly-assigned U.S. Pat. Nos. 6,465,090, 6,627,323, and 6,720,038. With each of these, alumina is a noted candidate as being an effective sacrificial additive or coating, in other words, reducing the impact of CMAS infiltration by reacting with CMAS (being sacrificially consumed) to raise the melting point and viscosity of CMAS. A number of approaches have been considered for applying alumina and other materials capable of inhibiting CMAS infiltration (hereinafter, CMAS inhibitors), including those disclosed by the above-identified commonly-assigned patents. Certain approaches are more effective at placing a CMAS inhibitor into the open porosity within the TBC, while others such as EB-PVD deposition, slurry top coats, and laser glazing tend to be more effective at depositing the CMAS inhibitor as a discrete outer layer on the TBC. In the case of alumina, the approach has generally been to provide alumina in the form of an additive layer overlying the TBC, rather than as a co-deposited additive within the TBC, since solid alumina and zirconia are essentially immiscible and the mechanism by which alumina provides CMAS protection is through sacrificial consumption. Nonetheless, it is desirable to have at least some alumina deposited in the open porosity of a TBC to maintain a level of CMAS protection in the event the alumina layer is breached or lost through spallation, erosion, and/or consumption.

Chemical vapor deposition (CVD) processes have been shown to be capable of being optimized for either higher deposition rates that primarily deposit alumina as a discrete additive layer on the outer TBC surface, or lower deposition rates that promote infiltration of a relatively small amount of alumina into the open porosity of a TBC. Spallation tests with CMAS contamination have indicated that TBC's protected with either approach exhibit similar CMAS resistance, even though those primarily infiltrated with alumina have much lower alumina contents. However, the CVD deposition of alumina with good penetration into the porosity of a TBC generally requires expensive specialized equipment and is typically limited to very low deposition rates.

Another approach capable of infiltrating a TBC with a CMAS inhibitor is liquid infiltration with a precursor of the inhibitor. To be successful, the precursor and any solvents, carriers, etc., used therewith must not damage the TBC, other layers of the TBC system, or the substrate protected by the TBC system. Other key requirements for a successful liquid infiltration approach include achieving an adequate degree of infiltration and depositing an effective quantity of alumina. To promote the latter, the precursor should contain a relatively high level of aluminum that can be converted to yield a known or predictable amount of alumina. Some known alumina precursors and their conversion efficiencies include aluminum chloride (0.237), aluminum bromide (0.128), aluminum acetate (0.161), aluminum nitrate (0.052), and aluminum sulfate (0.033). However, these sulfate and halide compounds are known to attack bond coat and superalloy materials typically present in TBC applications, and aqueous solutions of these compounds exhibit poor wettability to TBC materials. For those precursors requiring a solvent or carrier, another important consideration is the solubility of the precursor in its carrier since a precursor with a high conversion efficiency will not be effective if only a small loading of the precursor can be placed into solution.

As indicated above, the degree of infiltration is associated with the ability of the system to wet and flow into the very small pores found in TBC's produced by such methods as PVD and plasma spraying. The precursor-containing liquid being infiltrated must be able to wet the TBC surface and quickly flow into its small pores. These characteristics are associated with the surface tension and viscosity of the liquid. Excessively high surface tensions and viscosities will result in a CMAS inhibitor located primarily on the TBC surface where it is susceptible to erosion and spallation loss.

In view of the above, while various approaches are known for depositing alumina and other CMAS inhibitors, there is an ongoing need for deposition methods capable of depositing an effective amount of a CMAS inhibitor on and/or within a TBC that will optimize the ability of the inhibitor to prevent damage from CMAS infiltration.

### BRIEF SUMMARY OF THE INVENTION

The present invention generally provides a process for protecting a thermal barrier coating (TBC) on a component used in a high-temperature environment, such as the hot section of a gas turbine engine. The invention is particularly directed to a process by which a CMAS inhibitor is applied so as to form a protective deposit on the surface of the TBC as well as infiltrate porosity within the TBC, thereby providing the benefits of an additive portion overlying the TBC and available for sacrificial consumption as well as an internal portion within the TBC to maintain a level of CMAS protection in the event the additive portion is breached or lost through spallation, erosion, and/or consumption.

The process of this invention generally entails applying to a surface of the TBC a liquid containing at least one alumina precursor chosen from the group consisting of long chain aluminum alkoxides, aluminum beta-diketonates, aluminum carboxylates, and aluminum alkyls. The liquid is applied so as to form a liquid film on the TBC surface, and has viscosity and wetting properties that cause the liquid to infiltrate porosity within the TBC beneath its surface. The TBC is then heated to convert the alumina precursor to alumina. A first portion of the alumina forms a surface deposit on the TBC surface, while a second portion of the alumina forms an internal deposit within the porosity of the TBC.

In view of the above, the process of this invention produces a protective deposit capable of increasing the temperature capability of a TBC by reducing the vulnerability of the TBC to spallation and the underlying substrate to corrosion from CMAS contamination. As a result of the type of precursor used and the process by which the precursor is applied, the protective deposit can be formed so as to not only cover the surface of the TBC, but also extend protection into subsurface regions of the TBC where resistance to CMAS is also important for long-term resistance to CMAS contamination.

Other objects and advantages of this invention will be better appreciated from the following detailed description.

### BRIEF DESCRIPTION OF THE DRAWINGS

FIG. 1 is a perspective view of a high pressure turbine blade.

FIG. 2 is a cross-sectional view of a surface region of the blade of FIG. 1, and shows a protective deposit on a TBC in accordance with an embodiment of this invention.

### DETAILED DESCRIPTION OF THE INVENTION

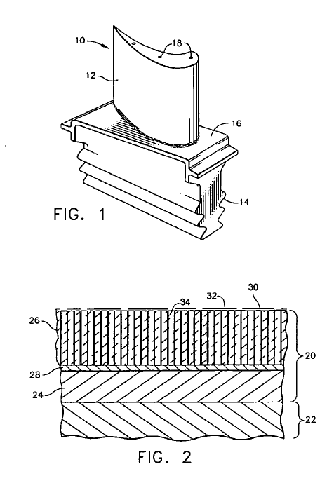

The present invention will be described in reference to a high pressure turbine blade 10 shown in FIG. 1, though the invention is applicable to a variety of components that operate within a thermally and chemically hostile environment. The blade 10 generally includes an airfoil 12 against which hot combustion gases are directed during operation of the gas turbine engine, and whose surfaces are therefore subjected to severe attack by oxidation, hot corrosion and erosion as well as contamination by CMAS. The airfoil 12 is anchored to a turbine disk (not shown) with a dovetail 14 formed on a root section 16 of the blade 10. Cooling holes 18 are present in the airfoil 12 through which bleed air is forced to transfer heat from the blade 10.

The surface of the airfoil 12 is protected by a TBC system 20, represented in FIG. 2 as including a metallic bond coat 24 that overlies the surface of a substrate 22, the latter of which is typically the base material of the blade 10 and preferably formed of a superalloy, such as a nickel, cobalt, or iron-base superalloy. As widely practiced with TBC systems for components of gas turbine engines, the bond coat 24 is preferably an aluminum-rich composition, such as an overlay coating of an MCrAlX alloy or a diffusion coating such as a diffusion aluminide or a diffusion platinum aluminide, all of which are well-known in the art. Aluminum-rich bond coats develop an aluminum oxide (alumina) scale 28, which grows as a result of oxidation of the bond coat 24. The alumina scale 28 chemically bonds a TBC 26, formed of a thermal-insulating material, to the bond coat 24 and substrate 22. The TBC 26 of FIG. 2 is represented as having a strain-tolerant microstructure of columnar grains. As known in the art, such columnar microstructures can be achieved by depositing the TBC 26 using a physical vapor deposition (PVD) technique, such as EBPVD. The invention is also applicable to noncolumnar TBC deposited by such methods as plasma spraying, including air plasma spraying (APS). A TBC of this type is in the form of molten “splats,” resulting in a microstructure characterized by irregular flattened (and therefore noncolumnar) grains and a degree of inhomogeneity and porosity.

As with prior art TBC's, the TBC 26 of this invention is intended to be deposited to a thickness that is sufficient to provide the required thermal protection for the underlying substrate 22 and blade 10. A suitable thickness is generally on the order of about 75 to about 300 micrometers. A preferred material for the TBC 26 is yttria-stabilized zirconia (YSZ), a preferred composition being about 3 to about 8 weight percent yttria (3-8% YSZ), though other ceramic materials could be used, such as nonstabilized zirconia, or zirconia partially or fully stabilized by magnesia, ceria, scandia or other oxides.

Of particular interest to the present invention is the susceptibility of TBC materials, including YSZ, to attack by CMAS. As discussed previously, CMAS is a relatively low melting compound that when molten is able to infiltrate columnar and noncolumnar TBC's, and subsequently resolidify to promote spallation during thermal cycling. To address this concern, the TBC 26 in FIG. 2 is shown as being provided with a protective deposit 30 of this invention. As a result of being on the outermost surface of the blade 10, the protective deposit 30 serves as a barrier to CMAS infiltration of the underlying TBC 26. The protective deposit 30 is shown in FIG. 2 as comprising an additive portion that overlies the surface 32 of the TBC 26 so as to be available for sacrificial reaction with CMAS, and further comprises an internal infiltrated portion that extends into porosity within the TBC 26 so as to maintain a level of CMAS protection in the event the additive portion is breached or lost through spallation, erosion, and/or consumption. In the case of the columnar TBC 26 schematically represented in FIG. 2, such porosity is represented in part as being defined by gaps 34 between individual columns of the TBC 26. However, porosity is also likely to be present within the columns, for example, in the surfaces of individual columns if the TBC 26 were deposited by EB-PVD to have a feather-like grain structure as known in the art.

As represented in FIG. 2, the additive portion of the protective deposit 30 may form a discontinuous layer on the outer surface 32 of the TBC 26. As such, a suitable amount of the protective deposit 30 for protecting the TBC 26 is believed to be best quantified by weight per unit TBC surface area. For example, a suitable amount of protective deposit 30 is about 1 to 10 mg/cm² of surface area for an EBPVD TBC having a thickness of about three to ten mils (about 75 to about 250 micrometers), with a more preferred amount for such a coating being about 1.5 to 6 mg/cm². The degree to which the internal portion of the protective deposit 30 occupies the gaps 34 between TBC grains will depend in part on the particular composition used to form the protective deposit 30, as discussed in greater detail below, and particularly on the structure of the TBC 26, with more open porosity receiving (and needing) greater amounts of the internal deposit.

According to a preferred aspect of the invention, the protective deposit 30 contains alumina, more preferably is predominantly alumina, and may consist entirely of alumina, though other compounds could be used such as the sacrificial coating materials disclosed in the above-noted patents to Hasz et al., whose contents relating to such sacrificial coating materials are incorporated herein by reference. The alumina content of the protective deposit 30 is sacrificially consumed by reacting with molten CMAS that deposits on the deposit 30 and possibly infiltrates the gaps 34 of the TBC 26, and in doing so forms one or more refractory phases with higher melting temperatures than CMAS. In effect, the alumina content of the molten CMAS is increased, yielding a modified CMAS with a higher melting and/or greater viscosity. As a result, the reaction product of CMAS and the alumina content of the protective deposit 30 more slowly infiltrates the TBC 26 and tends to resolidify before sufficient infiltration has occurred to cause spallation.

According to the invention, the protective deposit 30 is formed by applying to the TBC surface 32 a coating liquid containing an alumina precursor, more particularly one or more metallo-organic (organometallic) compounds that contain aluminum, and preferably one or more long chain aluminum alkoxides (Al(OR)₃), aluminum carboxylates (Al(RCOO)₃), aluminum beta-diketonates (Al(R₂C₃O₂)₃), and aluminum alkyls (AlR₃), where R is an alkyl or aryl organic fragment. Most preferred of these are aluminum isopropoxide (Al(OC₃H₇)₃) and aluminum s-butoxide (Al(OC₄ H₉)₃). These precursors are believed to have adequate alumina conversion capability and are non-corrosive to the TBC system 20 (e.g., yttria-stabilized zirconia of the TBC 26, aluminum and aluminides of the bond coat 24, and alumina of the scale 28) or the underlying superalloy substrate 22. Long chain aluminum alkoxides, beta-diketonates, alkyls, and carboxylates such as aluminum isopropoxide, aluminum s-butoxide, aluminum methoxide, aluminum ethoxide, and aluminum acetylacetonate, and particularly aluminum isopropoxide and aluminum s-butoxide, further have the advantage of low melting points (about 128 to 132° C. for aluminum isopropoxide and below room temperature for aluminum s-butoxide), allowing a coating liquid consisting entirely of the precursor to be used. However, the preferred precursors are also highly soluble in organic solvents. By dissolving the precursors in a suitable solvent, improved wettabilty and reduced viscosity result, thereby promoting the infiltration of the intra-columnar gaps 34 of the TBC 26. Particularly suitable solvents are believed to be those with a polarity equal to or less than that of acetone, with preferred solvents believed to be acetone, xylene, hexane, toluene, methyl ethyl ketone (MEK), and furan.

The coating liquid may optionally contain a suspension of fine alumina particles. To promote infiltration of the liquid into the porosity (e.g., gaps 34) of the TBC 26, the alumina particles are preferably limited to a mean diameter of less than one micrometer and do not constitute more than 20 volume percent of the liquid, with a suitable volume content believed to be in a range of about 5 to about 10 percent.

Application of the coating liquid to the TBC 26 can be by dipping or spraying, though other application techniques are also possible. Once deposited, the coating liquid forms a liquid film that both overlies the TBC surface 32 as well as penetrates the TBC 26 through the open porosity within the TBC 26, such as the gaps 34 between columns. The film is optionally dried to evaporate excess moisture from the liquid for the purpose permitting handling, after which the component 10 is heated to convert the precursor to alumina. In the case of the preferred aluminum isopropoxide and aluminum s-butoxide precursors, suitable conversion temperatures are in a range of about 300 to about 1100° C. The application and heating steps may be repeated multiple times to achieve the targeted weight gain per unit area of the TBC surface 32. As an aid to increase the infiltration efficiency, a vacuum or pressure infiltration technique may be used, and/or the coating liquid and/or component 10 can be heated to reduce the viscosity of the applied liquid.

There are various opportunities for depositing the protective deposit 30 of this invention. For example, the deposit 30 can be applied to newly manufactured components that have not been exposed to service. Alternatively, the deposit 30 can be applied to a component that has seen service and whose TBC must be cleaned and rejuvenated before being returned to the field. In the latter case, applying the deposit 30 to the TBC can significantly extend the life of the component beyond that otherwise possible if the TBC was not protected by the deposit 30. In addition, the deposit 30 may be deposited on only those surfaces of a component that are particularly susceptible to damage from CMAS infiltration. In the case of the blade 10 shown in FIG. 1, of particular interest is often the concave (pressure) surface of the airfoil 12, which is significantly more susceptible to attack than the convex (suction) surface as a result of aerodynamic considerations. The deposit 30 can be selectively deposited on the concave surface of the airfoil 12, thus minimizing the additional weight and cost of the deposit 30. For this purpose, preferred deposition techniques include spraying the coating liquid. While the concave surface of the airfoil 12 may be of particular interest, circumstances may exist where other surface areas of the blade 10 are of concern, such as the leading edge of the airfoil 12 or the region of the convex surface of the airfoil 12 near the leading edge.

In an investigation leading to the present invention, nickel-base superalloy specimens having a columnar 7% YSZ TBC deposited by EB-PVD on a PtAl diffusion bond coat were prepared. Some of these specimens were set aside as control samples, while other (experimental) specimens were dipped in a solution of aluminum s-butoxide and xylene at a volume ratio of 85/15. After drying, the experimental specimens were heated to about 700° C. for a duration of about 120 minutes, during which time the xylene evaporated and the aluminum s-butoxide was converted to alumina. The dipping, drying, and heating process was then repeated for the experimental specimens, resulting in a weight gain of about 2.5 mg/cm² per specimen. About 33 mg of a synthetically-prepared CMAS composition was then applied to an approximately 2.5 cm² surface area of each control and experimental specimen, after which all specimens underwent one-hour cycles between room temperature and about 1230° C. until spallation of the TBC occurred. The average life for the experimental specimens was about 2.4 times that of the untreated control samples. SEM analysis of the experimental specimens confirmed that alumina had infiltrated the columnar gaps of the TBC.

In another investigation, specimens essentially identical to that of the previous investigation underwent essentially identical processing and testing, with the exception that a solution of aluminum s-butoxide and xylene at a volume ratio of 95/5 was used as the infiltrant, and the experimental specimens were dipped four times in the solution, resulting in a weight gain of about 4 mg/cm² per specimen. The average life for the experimental specimens was about 4 times that of the untreated control samples of the previous investigation. Similar investigations were then performed with acetone, hexane, and MEK as the solvent for aluminum s-butoxide, with similar results.

In a third investigation, specimens essentially identical to that of the previous investigations were infiltrated with a solution of aluminum isopropoxide and xylene at a volume ratio of 50/50, to which about 10% by volume of submicron alumina particles were added. After air drying, the airfoil was heated to about 700° C. and held for a duration of about 120 minutes, during which time the xylene evaporated and the aluminum isopropoxide was converted to alumina. The infiltration and bake cycle was repeated for a total of two infiltration/bake cycles, resulting in a weight gain of about 1.5 mg/cm² per specimen. The average life for the experimental specimens was about 1.7 times that of the untreated control samples of the first investigation.

While the invention has been described in terms of a preferred embodiment, it is apparent that other forms could be adopted by one skilled in the art, such as by substituting other TBC, bond coat, and substrate materials, or by utilizing other or additional methods to deposit and process the protective deposit. Accordingly, the scope of the invention is to be limited only by the following claims.

What is claimed is:

1. A process for protecting a thermal barrier coating on a surface of a component, the process comprising the steps of:
applying to a surface of the thermal barrier coating a liquid containing at least one alumina precursor chosen from the group consisting of long chain aluminum alkoxides, beta-diketonates, alkyls, and carboxylates, the liquid being applied so as to form a liquid film on the surface, the liquid having viscosity and wetting properties that cause the liquid to infiltrate porosity within the thermal barrier coating beneath the surface; and then
heating the thermal barrier coating to convert the alumina precursor to alumina, a first portion of the alumina forming a surface deposit on the surface of the thermal barrier coating and a second portion of the alumina forming an alumina internal deposit within the porosity of the thermal barrier coating.

2. A process according to claim 1, wherein the liquid is non-corrosive to yttria-stabilized zirconia, aluminum, aluminides, and alumina.

3. A process according to claim 1, wherein the alumina precursor comprises at least one aluminum alkoxide.

4. A process according to claim 1, wherein the alumina precursor comprises at least one aluminum carboxylate.

5. A process according to claim 1, wherein the alumina precursor comprises at least one aluminum beta-diketonate or at least one aluminum alkyl.

6. A process according to claim 1, wherein the alumina precursor comprises at least one of aluminum isopropoxide and aluminum s-butoxide.

7. A process according to claim 1, wherein the liquid consists essentially of the alumina precursor in a liquid state.

8. A process according to claim 1, wherein the liquid consists essentially of the alumina precursor dissolved in an organic solvent.

9. A process according to claim 8, wherein the solvent has a polarity of equal to or less than acetone.

10. A process according to claim 8, wherein the solvent is chosen from the group consisting of xylene, toluene, acetone, hexane, methyl ethyl ketone, furan, and mixtures thereof.

11. A process according to claim 1, wherein the liquid contains alumina particles having a mean diameter of less than one micrometer.

12. A process according to claim 1, wherein infiltration of the porosity by the liquid is aided by applying heat, pressure, or a vacuum to the liquid during the applying step.

13. A process according to claim 1, further comprising the step of evaporating moisture from the liquid before the heating step.

14. A process according to claim 1, wherein the applying and heating steps are repeated at least once to increase the amount of alumina on the surface and within the porosity of the thermal barrier coating.

15. A process according to claim 1, wherein the first and second portions of the alumina are present on and within the thermal barrier coating at a level of about 1 to 10 milligrams per square centimeter of the surface of the thermal barrier coating.

16. A process according to claim 1, wherein the component is an airfoil component of a gas turbine engine.

17. A process according to claim 1, wherein the thermal barrier coating has a columnar grain structure.

18. A process according to claim 1, wherein the thermal barrier coating has a noncolumnar grain structure.

19. A process of forming a protective deposit on a thermal barrier coating of yttria-stabilized zirconia that is present on a gas turbine engine component, the protective deposit defining an external surface of the component, the process comprising the steps of:
applying to a surface of the thermal barrier coating a liquid that is non-corrosive to yttria-stabilized zirconia, aluminum, aluminides, and alumina and contains at least one alumina precursor chosen from the group consisting of long chain aluminum alkoxides and aluminum carboxylates, the liquid being applied so as to form a liquid film on the surface, the liquid having viscosity and wetting properties that cause the liquid to infiltrate porosity within the thermal barrier coating beneath the surface; and then
heating the thermal barrier coating to convert the alumina precursor to alumina, a first portion of the alumina forming a surface deposit on the surface of the thermal barrier coating and a second portion of the alumina forming an internal deposit within the porosity of the thermal barrier coating;
wherein the first and second portions of the alumina are present on and within the thermal barrier coating at a level of about 1 to 10 milligrams per square centimeter of the surface of the thermal barrier coating.

20. A process according to claim 19, wherein the liquid is selectively applied to the surface of the thermal barrier coating but not other surfaces of the thermal barrier coating.
